(19) United States
(12) Patent Application Publication
(10) Pub. No.: US 2007/0057526 A1
(43) Pub. Date: Mar. 15, 2007

(54) Vehicle with interchangeable accessories

(76) Inventors: Jason A. Bigelow, Ypsilanti, MI (US); Thomas L. Eby, Maybe, MI (US)

Correspondence Address: HARNESS, DICKEY & PIERCE, P.L.C., P.O. BOX 828, BLOOMFIELD HILLS, MI, 48303, US

(21) Appl. No.: 11/519,191

(22) Filed: Sep. 11, 2006

Related U.S. Application Data
(60) Provisional application No. 60/715,915, filed on Sep. 9, 2005.

(51) Int. Cl. B60N 2/02

(52) U.S. Cl. 296/65.03

(57) ABSTRACT

A utility vehicle can utilize interchangeable accessories to alter the functionality of the utility vehicle. The interchangeable accessories can be easily attached to and removed from the utility vehicle by hand and without the use of tools. The interchangeable accessories can utilize common retaining features on the utility vehicle to be secured thereto. Additionally, the interchangeable accessories can utilize the same locking mechanisms to be secured to the utility vehicle.

### CROSS-REFERENCE TO RELATED APPLICATIONS

This application claims the benefit of U.S. Provisional Application No. 60/715,915, filed on Sep. 9, 2005. The disclosure of the above application is incorporated herein by reference.

### FIELD

The present disclosure relates to utility vehicles with interchangeable accessories and to quick-release mechanisms for attaching the interchangeable accessories to the utility vehicle.

### BACKGROUND AND SUMMARY

The statements in this section merely provide background information related to the present disclosure and may not constitute prior art.

Vehicle users continue to demand increased utility and functionality for utility vehicles. To this end, these users demand increased flexibility for storage and seating in utility-type vehicles. Increasing the flexibility and functionality of a utility vehicle allows the utility vehicles to be utilized more often and to perform additional tasks. Thus, increasing the functionality of a utility vehicle can increase its usefulness and its utilization. Accordingly, it would be advantageous to provide a utility vehicle that can have its functionality altered to perform different tasks.

It would be further advantageous if the switching of the functionality of the utility vehicles were able to be accomplished quickly and easily. Moreover, it would be advantageous if no special tools or any tools at all were necessary to change the functionality of the utility vehicle. Thus, it would be advantageous to provide a utility vehicle having a functionality that can be easily and quickly changed and the changing operation can be performed without the use of tools.

To satisfy this need, a utility vehicle with interchangeable accessories is taught. The interchangeable accessories can enable the functionality of the vehicle to be varied. The ability of the vehicle to have interchangeable accessories can increase the utility or functionality of the vehicle. The increased functionality can allow the vehicle to be used more frequently and to perform additional tasks. Additionally, the interchangeable accessories can be easily changed by hand without the use of tools. To this end, the interchangeable accessories utilize coupling or latching mechanisms for affixing the accessories to the utility vehicle. The latching mechanisms can utilize pivotally rotatable handles coupled to latching bars or members. The latching bars can include hook portions that can be engaged with apertures on the vehicle. The interchangeable accessories can rest on bearing surfaces of the utility vehicle and can be secured thereto with the latching mechanisms.

A removable seat accessory according to the present teachings can be coupled to a vehicle having a bed defined by a pair of side support walls. The seat accessory includes a frame and a seat coupled to the frame. A locking member is coupled to the frame and has a rotatable handle moveable between a disengaged and engaged position. A hook portion of the locking member is configured to engage an aperture on the vehicle. The removable seat accessory can be selectively attached to the vehicle and secured thereto by moving the locking member to the engaged position and can be removed from the vehicle when the locking member is in the disengaged position.

A removable accessory for a utility vehicle having a rear bed defined by a lower surface and pair of side support walls according to the present teachings includes a frame and a support surface coupled to the frame. The support surface and frame form at least one of a removable rear-facing seat, a removable storage box, and a removable generally horizontal support platform that extends rearwardly beyond a rear bumper of the vehicle when attached thereto. A locking member coupled to the frame can be moved between a disengaged position and an engaged position. The locking member has an engaging portion configured to engage a retaining feature on the vehicle. The removable accessory can be selectively attached to the vehicle and secured thereto by moving the locking member to the engaged position and can be removed from the vehicle when the locking member is in the disengaged position.

A reconfigurable utility vehicle according to the present teachings includes a front portion including a driver's area and a rear portion including a rear bed having a lower surface and upwardly extending support walls. A retainer having an opening therein is disposed adjacent a top surface of the support walls. The vehicle has a rear hitch. A plurality of interchangeable accessories can be selectively coupled to and removed from the vehicle to change a configuration of the vehicle. The accessories include at least two of a golfing accessory having a bag support member and a basket, a rear-facing seat, a storage bed, and a rearwardly extending platform.

A removable support rack according to the present teachings can be configured to be selevtively coupled to a rear transversely extending beam of a vehicle. The support rack includes a platform portion having a pair of locking flanges configured to engage the transverse beam and a locking mechanism having an actuable handle and a locking arm. The locking arm is configured to engage an aperture defined on the vehicle.

Further areas of applicability will become apparent from the description provided herein. It should be understood that the description and specific examples are intended for purposes of illustration only and are not intended to limit the scope of the present claims.

### DRAWINGS

The drawings described herein are for illustration purposes only and are not intended to limit the scope of the present teachings in any way.

FIG. 1 is a perspective view of a utility vehicle with an interchangeable golfing accessory attached thereto according to the present teachings;

FIG. 2 is a perspective view of a utility vehicle with an interchangeable rear-facing seat accessory and an interchangeable support rack accessory attached thereto according to the present teachings;

FIG. 3A is a perspective view of a utility vehicle with an interchangeable storage box accessory attached thereto according to the present teachings;

FIG. 3B is a perspective view of the utility vehicle of FIG. 3A with the interchangeable support rack accessory attached thereto in addition to the interchangeable storage box accessory according to the present teachings;

FIG. 4 is an exploded view of the interchangeable golfing accessory illustrating the ability to removably attach it to the vertical support of the utility vehicle;

FIG. 5 is an exploded front plan view of the golf club support structure and basket of FIG. 4;

FIG. 6 is a bottom plan view of a portion of the vertical support and basket of FIG. 4;

FIG. 7 is a fragmented cross-sectional view along line 7-7 of FIG. 1;

FIG. 8 is a fragmented perspective view of the utility vehicle of FIG. 2 with the seat cushions and floor panel removed from the rear-facing seat and support rack accessories;

FIG. 9 is an exploded perspective view of the support rack accessory of FIG. 8 removed from the utility vehicle;

FIG. 10 is a perspective view of the support rack accessory and the rear bumper portion of the utility vehicle;

FIGS. 11-13 are perspective views of the support rack accessory and rear bumper portion illustrating the attachment of the support rack accessory to the rear bumper portion of the utility vehicle;

FIG. 14 is a fragmented perspective view of the cross-vehicle beam of the rear bumper portion and the attachment of the support rack accessory thereto;

FIGS. 15A and B are perspective views of the lock mechanism used on the support rack accessory in a locked and unlocked state, respectively;

FIG. 16 is a perspective view of the rear-facing seat accessory removed from the utility vehicle;

FIGS. 17 and 18 are perspective views of the seat frame of the rear-facing seat accessory of FIG. 16 with the seat cushions removed;

FIG. 19A is a perspective view of one of the locking members of the rear-facing seat accessory of FIG. 18;

FIG. 19B is a perspective view of the bracket with hook utilized with the locking members of the rear-facing seat accessory;

FIG. 20 is a fragmented perspective view of the rear-facing seat accessory being positioned in the rear bed of the utility vehicle;

FIG. 21 is an enlarged fragmented view within circle 21 of FIG. 20;

FIG. 22 is a perspective view of the rear-facing seat accessory installed in the rear bed of the utility vehicle with the locking members in the unlocked position;

FIG. 23 is a perspective view of the rear-facing seat accessory installed in the rear bed of the utility vehicle with the locking members in the locked position;

FIGS. 24A and B are fragmented side plan views of one of the locking members of the rear-facing seat accessory engaged with the receiver plate of the utility vehicle in the unlocked and locked positions, respectively; and

FIGS. 25 and 26 are perspective views of the storage box accessory removed from the utility vehicle.

### DETAILED DESCRIPTION

The following description is merely exemplary in nature and is not intended to limit the present teachings, application, or uses.

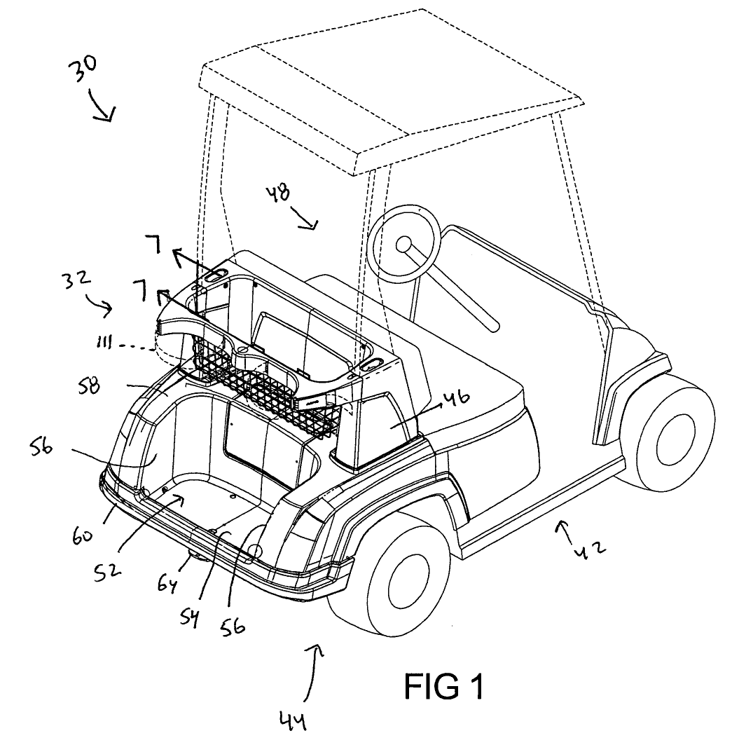

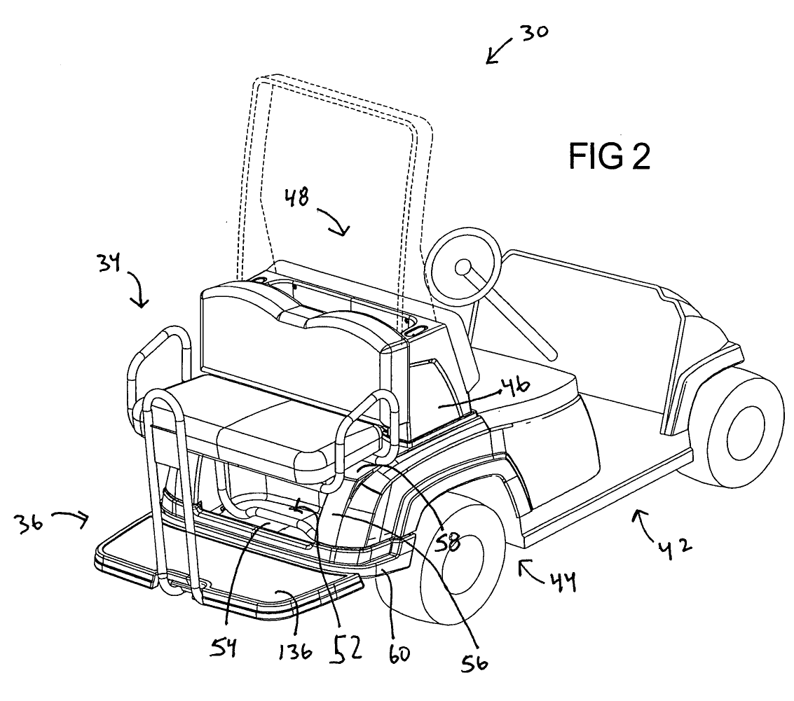

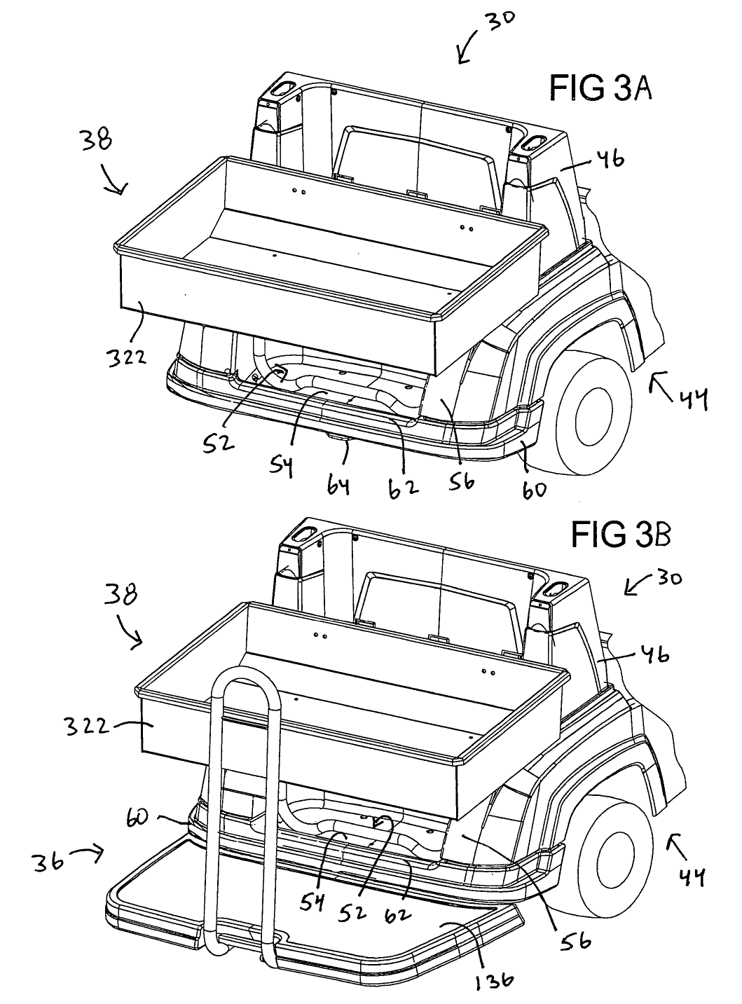

Referring to FIGS. 1-3B, a vehicle 30 with a plurality of interchangeable accessories attached thereto according to the present teachings is shown. Vehicle 30 can be a utility vehicle, such as a golf car, as shown. Utility vehicle 30 can have a plurality of different interchangeable accessories attached thereto in various combinations. The various interchangeable accessories can utilize the same or different features on vehicle 30 to be attached thereto. The various accessories can be attached without the use of tools (i.e., by hand). The various accessories enable utility vehicle 30 to be configured and utilized for varying activities. For example, as shown in FIG. 1, utility vehicle 30 can be configured as a golf car and include an interchangeable golfing accessory 32 attached to the rear of utility vehicle 30. As another example, as shown in FIG. 2, utility vehicle 30 can include an interchangeable rear-facing seat accessory 34 and/or an interchangeable rear support rack accessory 36 to enable additional people to be transported in utility vehicle 30 and support their feet and/or other items. As yet another example, as shown in FIG. 3A, utility vehicle 30 can include a storage box accessory 38 for facilitating the transport of loose or packaged items with utility vehicle 30. Additionally, as shown in FIG. 3B, utility vehicle 30 can be configured with both storage box accessory 38 and support rack accessory 36 to enable the transport of additional items.

Utility vehicle 30 includes a front portion 42 and a rear portion 44. A vertical support member 46 can separate front and rear portions 42, 44. Front portion 42 can include a front seating area 48 and the mechanisms enabling a driver of utility vehicle 30 to control the operation of utility vehicle 30. Rear portion 44 can include a rear bed 52 having a lower surface 54 and a pair of depending side portions 56 extending upwardly from lower surface 54. Lower surface 54 and side portions 56 can be formed by body panels which are coupled to the frame or other structural components of utility vehicle 30. Side portions 56 can have top bearing surfaces 58 configured to support a load placed thereon. A rear bumper 60 is coupled to the frame of utility vehicle 30 and can include a rear lip 62 that is elevated above lower surface 54. Rear portion 44 can also include a hitch 64 (FIG. 3A) that extends beyond rear bumper 60 and is coupled to the frame of utility vehicle 30. Hitch 64 includes an opening 66 extending therethrough.

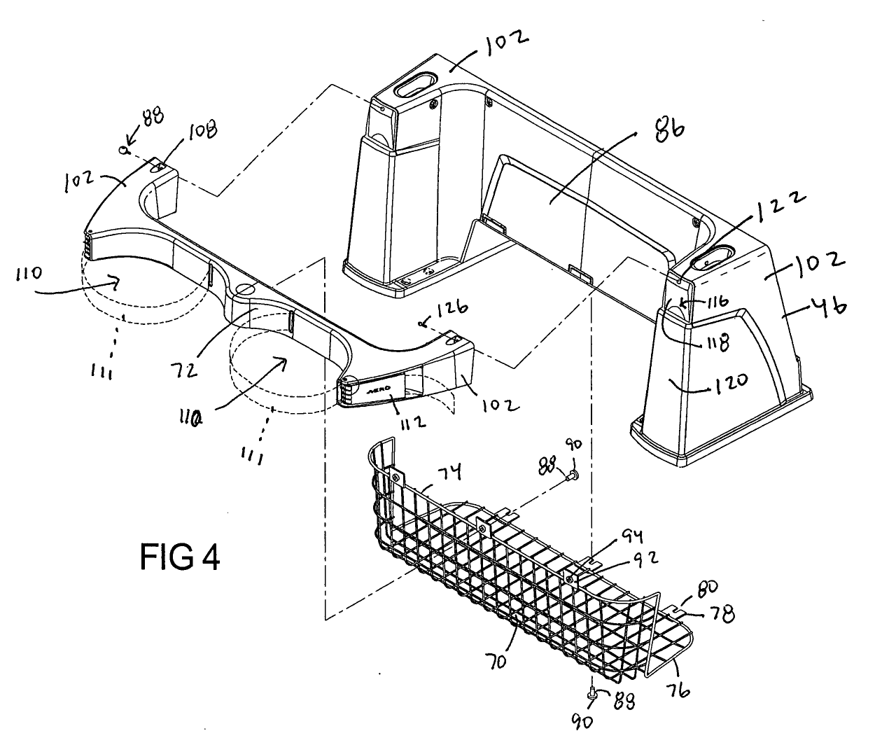

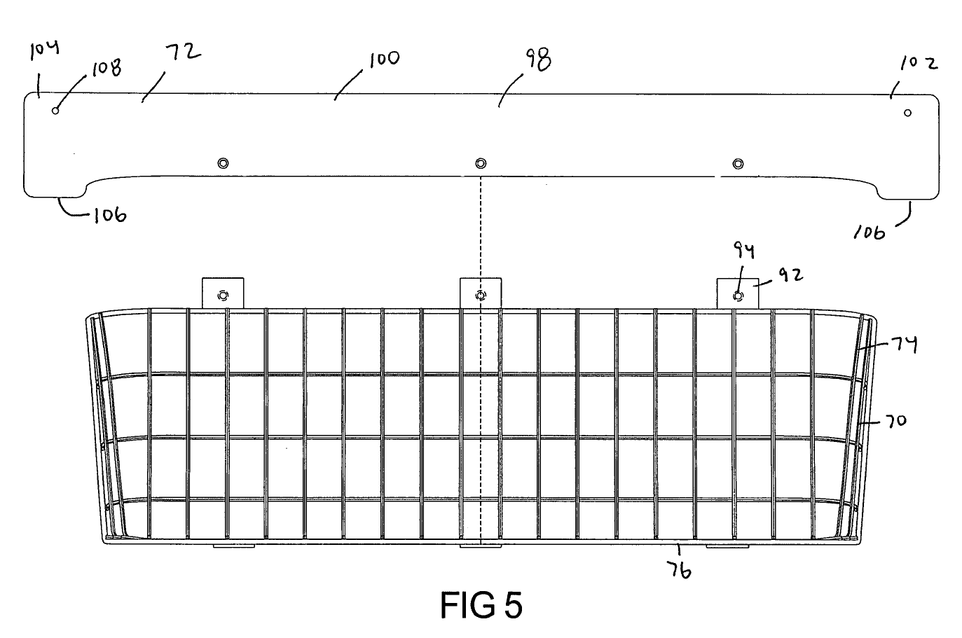

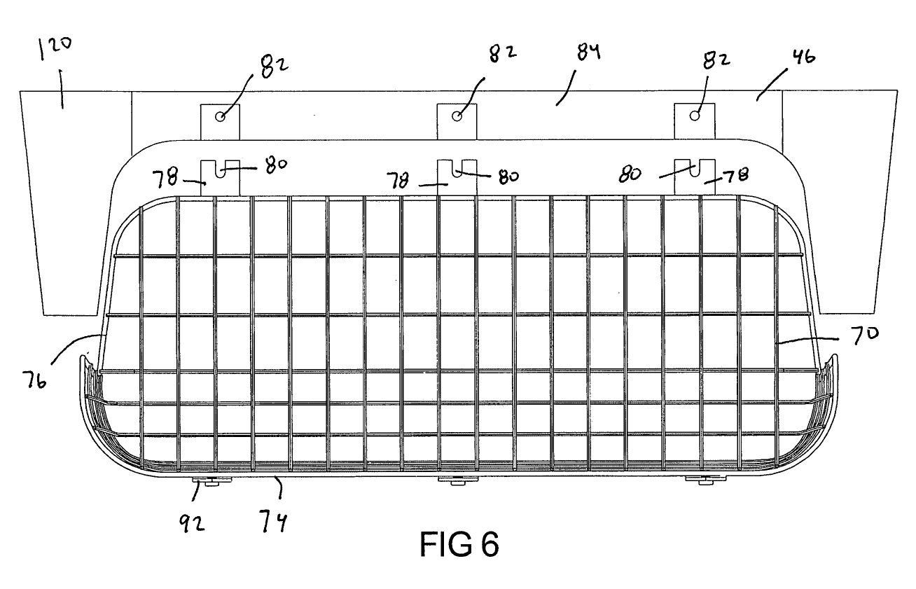

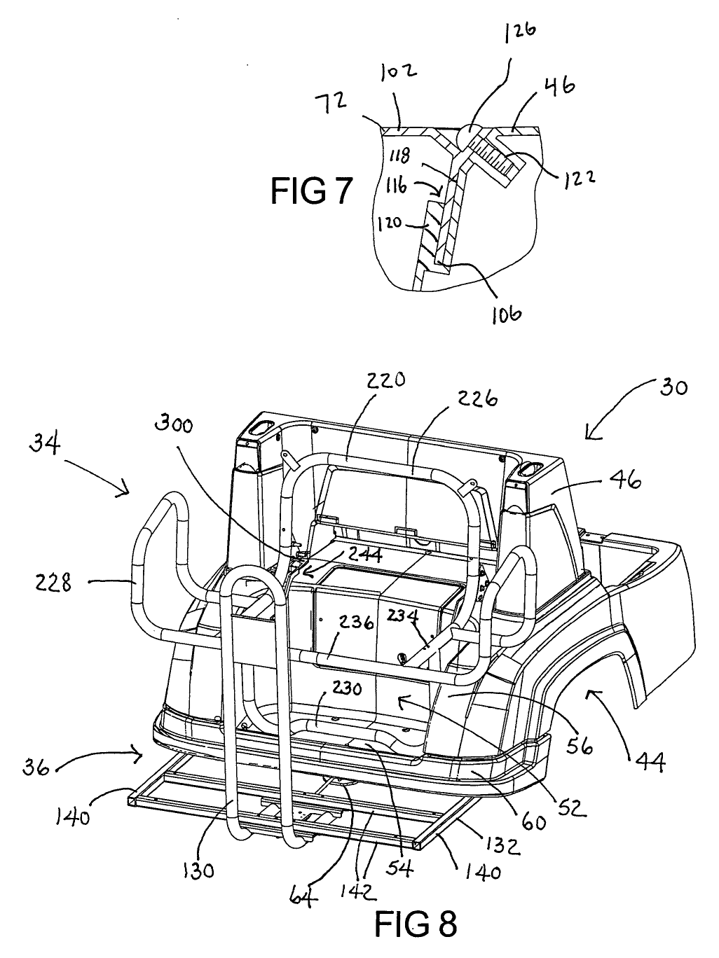

Referring now to FIGS. 1 and 4-7, details of golfing accessory 32 and the attachment of golfing accessory 32 to vertical support 46 of utility vehicle 30 is shown. Golfing accessory 32 includes a basket 70 and a golf club support structure 72 that can both be removably attached to vertical support 46. Basket 70 and support structure 72 can be attached to vertical support 46 and removed therefrom without the use of any tools (i.e., by hand). Basket 70 includes a vertically extending portion 74 and a horizontally extending portion 76. Horizontal portion 76 includes a plurality of brackets 78 having open-ended slots 80 therein. Slots 80 align with threaded recesses 82 on the lower surface 84 of a central member 86 of vertical support 46. Threaded fasteners 88 having an enlarged head 90 can be utilized to secure brackets 78 and basket 70 to central member 86. Enlarged head 90 enables an individual to insert and remove fasteners 88 into and out of threaded recesses 82 without the use of tools (i.e., by hand). The use of open-ended slots 80 can facilitate the attachment of basket 70 to vertical support 46 while allowing for variations in vertical support 46 and support structure 72. Basket 70 can include a plurality of brackets 92 attached to the upper edge of vertical portion 74. Brackets 92 can include openings 94 that align with threaded openings 96 on a front surface 98 of a central portion 100 of support structure 72. Threaded fasteners 88 with enlarged head 90 can be inserted through openings 94 and engage with threaded openings 96 to secure basket 70 to support structure 72. Head 90 of fasteners 88 can be knurled to facilitate tightening and loosening of fasteners 88 by hand.

Support structure 72 includes transversely opposed end portions 102 each having a front surface 104 with a lower edge/lip 106 thereon. Each end portion 102 can also include an opening 108 configured to receive a fastener therethrough. Central portion 100 can include a pair of generally U-shaped recesses 110 that facilitate the disposing of an upper portion of golf bags therein. Straps 111 can be used to secure the golf bags in recesses 110. End portions 102 can each include a securing lever 112 to hold straps 111 in place. Edges 106 are configured to align with and be received in complementary recesses 116 on rear surfaces 118 of vertically extending end portions 120 of vertical support 46. Rear surfaces 118 can also include threaded recesses 122 to receive a threaded fastener to hold support structure 72 to vertical support 46.

To attach golfing accessory 32 to utility vehicle 30, support structure 72 is aligned with vertical support 46 with front surfaces 104 substantially coplanar with and above rear surfaces 118. Edges 106 are aligned with recesses 116 and support structure 72 is moved vertically downwardly until edges 106 are firmly engaged with recesses 116. Fasteners can then be inserted through openings 108 and secured to threaded recesses 122 in vertical support 46. Specifically, fasteners 88 with enlarged heads 90 can be inserted through openings 108 and into threaded recesses 122. Thus, support structure 72 can be attached to vertical support 46 by hand and without the use of any tools. If desired, however, fasteners 126 requiring the use of a tool can be inserted through openings 108 and engaged with threaded recesses 122 to retain support structure 72 to vertical support 46. The use of fasteners 126 that require the use of a tool may be advantageous where the easy removability of support structure 72 from vertical support 46 is desired to be inhibited.

With support structure 72 attached to vertical support 46, basket 70 can be attached to vertical support 46 and support structure 72. Openings 94 in brackets 92 are aligned with threaded openings 96 in front surface 98 of support structure 72. Fasteners 88 are then inserted through openings 94 and engaged with threaded openings 96 and tightened to secure basket 70 to support structure 72. Slots 80 in brackets 78 are aligned with threaded recesses 82 in lower surface 84 of vertical support 46. Fasteners 88 are inserted through slots 80, engaged with threaded recesses 82, and tightened to secure basket 70 to vertical support 46. If desired, threaded fasteners 88 securing basket 70 to support structure 72 and vertical support 46 can remain in a loose state until all of the fasteners 88 are engaged with the associated threaded recess and basket 70 aligned. The threaded fasteners 88 can then all be tightened by hand. It should be appreciated that it may be possible to attach basket 70 to support structure 72 prior to attaching support structure 72 to vertical support 46. The removal of golfing accessory 32 from utility vehicle 30 can be done in substantially the reverse order of the attachment sequence. Thus, golfing accessory 32 can be attached to and removed from utility vehicle 30 by hand and without the use of any tools.

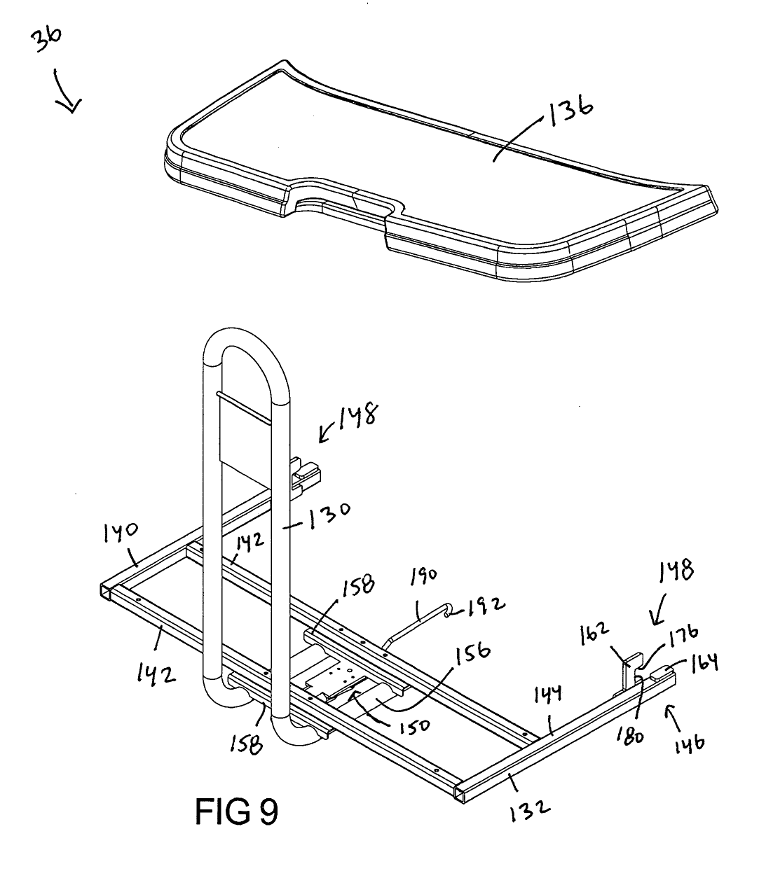

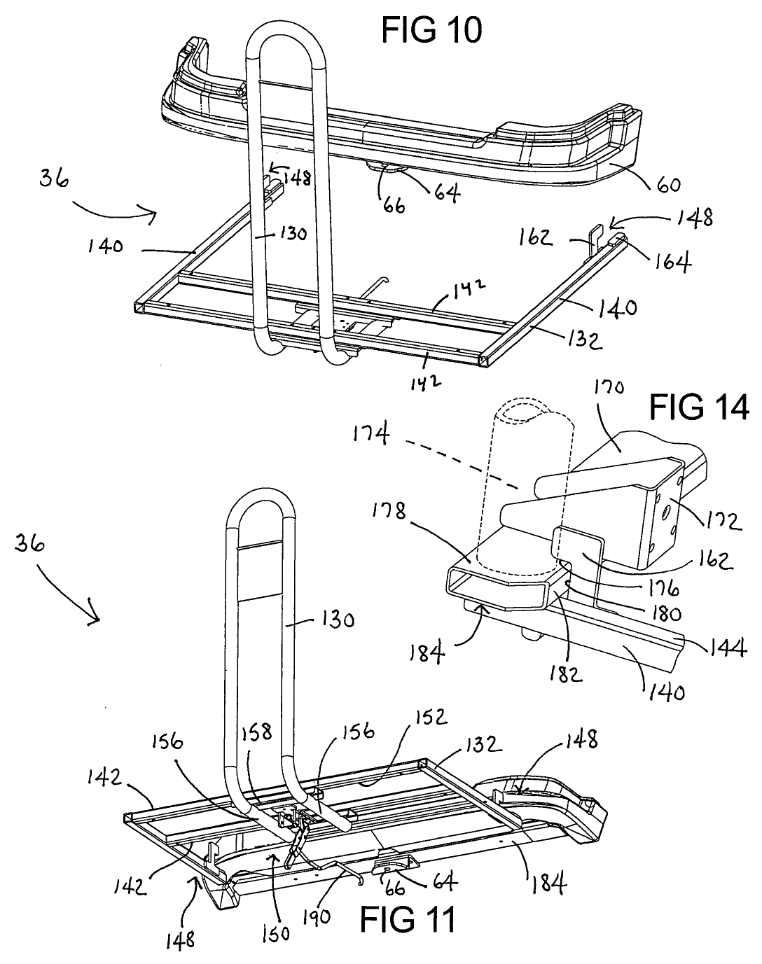

Referring now to FIGS. 2, 3B and 8-15, details of support rack accessory 36 are shown. Support rack accessory 36 includes a generally U-shaped handle portion 130 and a platform portion 132. Handle portion 130 can be substantially vertically oriented while platform portion 132 can be substantially horizontally oriented. A floor panel 136 can be disposed on platform portion 132 (FIG. 2). Floor panel 136 can be molded thermal plastic. Floor panel 136 can include a mat or bearing surface having a non-slip property or texture thereon. Floor panel 136 and platform portion 132 can be used as a footrest, such as when support rack accessory 36 is used in conjunction with rear-facing seat accessory 34 or as a support for objects being transported by vehicle 30. Platform portion 132 includes a pair of axial beams 140 interconnected by a pair of transverse beams 142. Beams 140, .142 have a top bearing surface 144 which supports floor panel 136. A front portion 146 of each axial beam 140 has a locking arrangement 148. Locking arrangements 148 facilitate the attachment of support rack accessory 36 to utility vehicle 30. A locking mechanism 150 is disposed on a lower side 152 of platform portion 132. Locking mechanism 150 can engage with hitch 64 to further secure support rack accessory 36 to utility vehicle 30.

Handle portion 130 includes a pair of generally horizontally oriented coupling members 156 that extend along lower side 152 of platform portion 132. Coupling members 156 are secured to a pair of brackets 158 which are coupled to transverse beams 142 on lower side 152. Whereas handle portion 130 is shown in a generally U-shaped configuration, it is envisioned that the handle can take other forms such as a T or L-shaped configuration also.

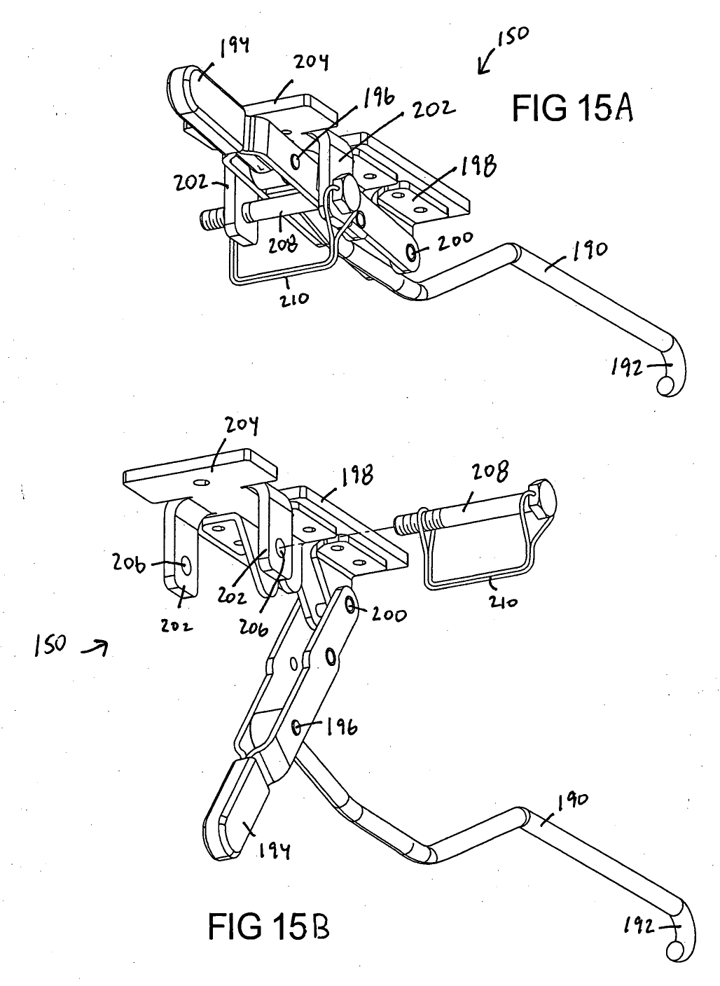

Locking arrangement 148 includes a generally L-shaped flange 162 that extends above top surface 144 of front portion 146 of each axial beam 140. Flange 162 can be welded to axial beam 140. Locking arrangement 148 also includes a support pad 164 attached to top surface 144 of front portion 146 of each axial beam 140 in front of flange 162. Support pad 164 can be part of axial beam 140 or a separate component that is welded or otherwise attached to axial beam 140. Locking arrangement 148, as shown in FIG. 14, facilitates the attachment of support rack accessory 36 to utility vehicle 30. Specifically, utility vehicle 30 can include a cross-vehicle beam 170 disposed in front of rear bumper 60. Each outboard end of cross-vehicle beam 170 can include a bracket 172 to facilitate attachment of rear bumper 60 or other components to cross-vehicle beam 170. Each outboard end of cross-vehicle beam 170 can also include a vertical member 174 (shown in phantom for clarity) disposed outboard of bracket 172.

Flange 162 can include a first bearing surface 176 that bears on a top bearing surface 178 of cross-vehicle beam 170. Flange 162 can include a second bearing surface 180 that can bear against a rear surface 182 of cross-vehicle beam 170. Support pad 164 can bear against a bottom bearing surface 184 of cross-vehicle beam 170. Flange 162 is disposed between bracket 172 and vertical member 174 when support rack accessory 36 is attached to utility vehicle 30. This arrangement limits the cross-vehicle movement of support rack accessory 36 relative to utility vehicle 30. Additionally, the engagement between locking arrangement 148 and cross-vehicle beam 170 provides both horizontal and vertical support for support rack accessory 36. The gravitational forces on support rack accessory 36, along with any forces exerted by objects placed thereon or by feet being rested thereon, cause an upward force to be applied to bottom bearing surface 184 through support pad 164. Additionally, these gravitational forces cause first bearing surface 176 of flange 162 to exert a downward force on top bearing surface 178 of cross-vehicle beam 170. In this manner, engagement of locking arrangement 148 with cross-vehicle beam 170 secures support rack accessory 36 to utility vehicle 30.

Locking mechanism 150 includes an axially extending locking rod 190 having a hook/latching portion 192 at a front end thereof. Hook 192 can be engaged in opening 66 in hitch 64. The rear portion of locking rod 190 is pivotally coupled to a handle 194 at pivot 196. Handle 194 is pivotally coupled to a front bracket 198 at pivot 200. Handle 194 can pivot about pivot 200 between a first unlocked position, as shown in FIG. 14B, to a second locked position, as shown in FIG. 14A. When handle 194 is in the second position, handle 194 can be in an over-center position. In this position, a forward axial force exerted on handle 194 by locking rod 190 does not tend to cause handle 194 to rotate about pivot 200 toward the first position. As such, handle 194 can be self-locking in the second position.

Movement of handle 194 between first and second positions axially moves locking rod 190. Handle 194, when in the second position, is disposed between a pair of downwardly extending flanges 202 in a rear bracket 204. Flanges 202 include aligned through openings 206 therein which enable a locking pin 208 to be inserted therethrough. Locking pin 208 can include a retaining member 210 that can retain locking pin 208 in openings 206 of flanges 202. For example, one end of retaining member 210 can be pivotally coupled to the head of locking pin 208 while the other end can extend around the opposite end of locking pin 208 to inhibit inadvertent removal of locking pin 208 from flanges 202. Locking pin 208, when engaged in flanges 202, can retain handle 194 in the second position and, thus, provide a redundant locking feature to maintain locking mechanism 150 in the locked state. Front and rear brackets 198, 204 are coupled to brackets 158 on lower side 152 of platform portion 132. Brackets 198, 204 can be a single integral bracket, if desired.

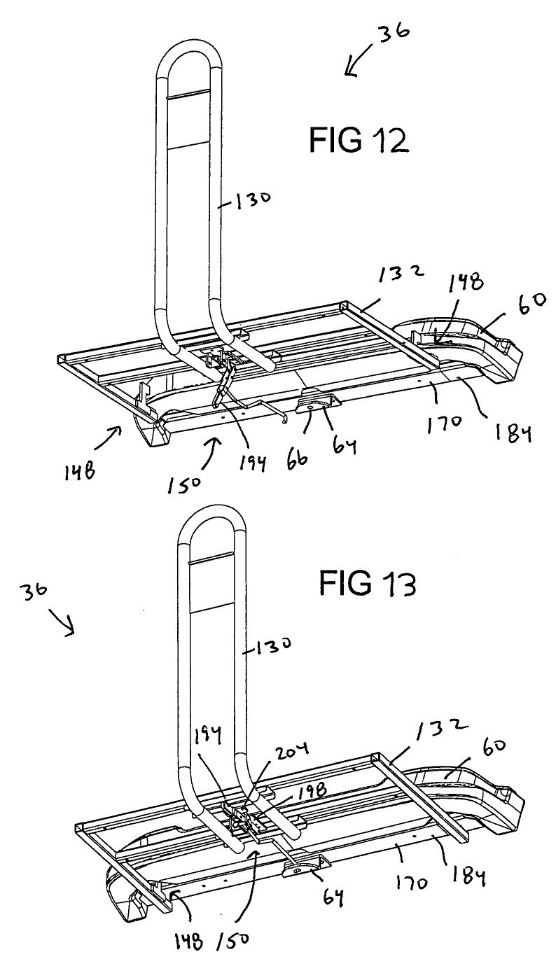

To attach support rack accessory 36 to utility vehicle 30, platform portion 132 is positioned adjacent the rear end of utility vehicle 30 with locking arrangement 148 adjacent rear bumper 60. Support rack accessory 36 continues to be moved so that locking arrangement 148 engages with cross-vehicle beam 170 with first and second bearing surfaces 176, 180 of flange 162 engaging the respective top bearing surface 178 and rear surface 182 of cross-vehicle beam 170 and support pad 164 engaging bottom bearing surface 184 of cross-vehicle beam 170. Handle 194 of locking mechanism 150 is moved to the first unlocked position, if not already in that position. Hook 192 is inserted through opening 66 in hitch 64. Handle 194 is then rotated rearwardly about pivot 200 from the first position, as shown in FIG. 12, to the second locked position, as shown in FIG. 13. When moved to the second position, hook 192 pulls support rack accessory 36 toward utility vehicle 30 to secure the engagement between second bearing surface 180 of flange 162 and rear surface 182 of cross-vehicle beam 170. With handle 194 in the second position, locking pin 208 is inserted through openings 206 in flanges 202. Retaining member 210 is then secured around the free end of locking pin 208 to inhibit the inadvertent removal of locking pin 208 from flanges 202. Support rack accessory 36 is thereby attached to utility vehicle 30 and can be used to support objects, feet, or other items placed thereon. To remove support rack accessory 36 from utility vehicle 30, the reverse sequence of the attachment steps is undertaken. Thus, rear-facing seat accessory 34 can be attached to and removed from utility vehicle 30 by hand without the use of any tools.

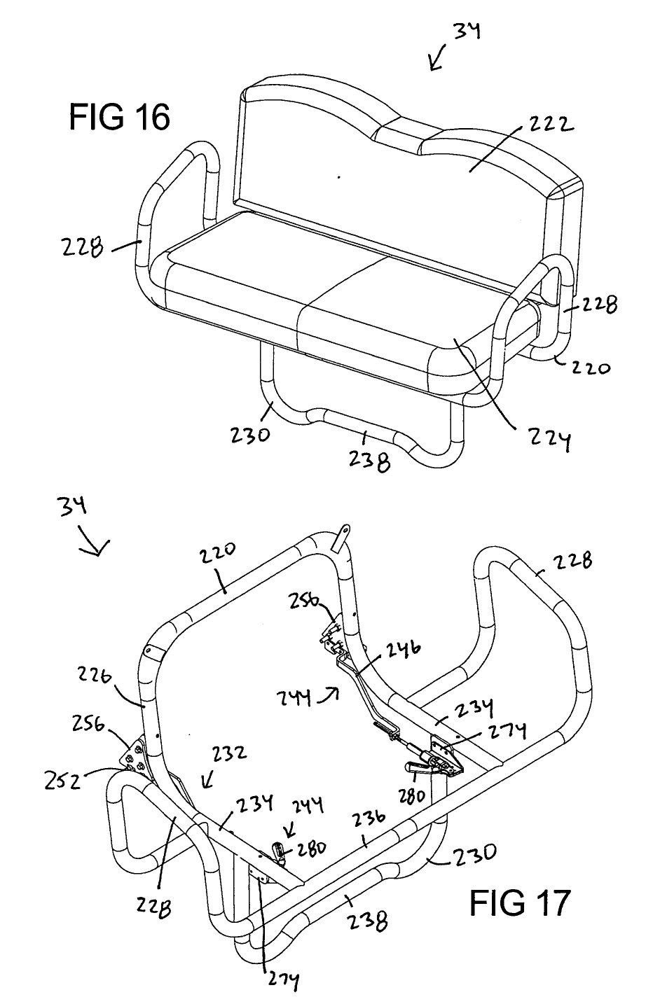

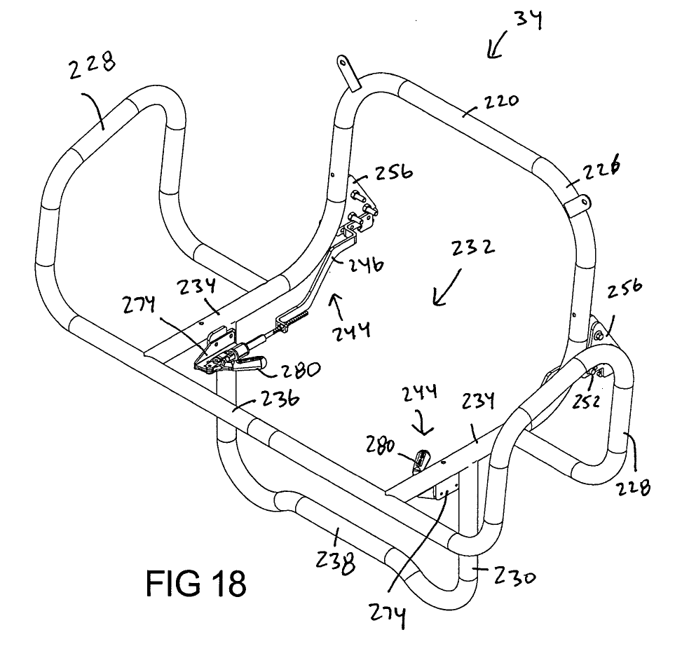

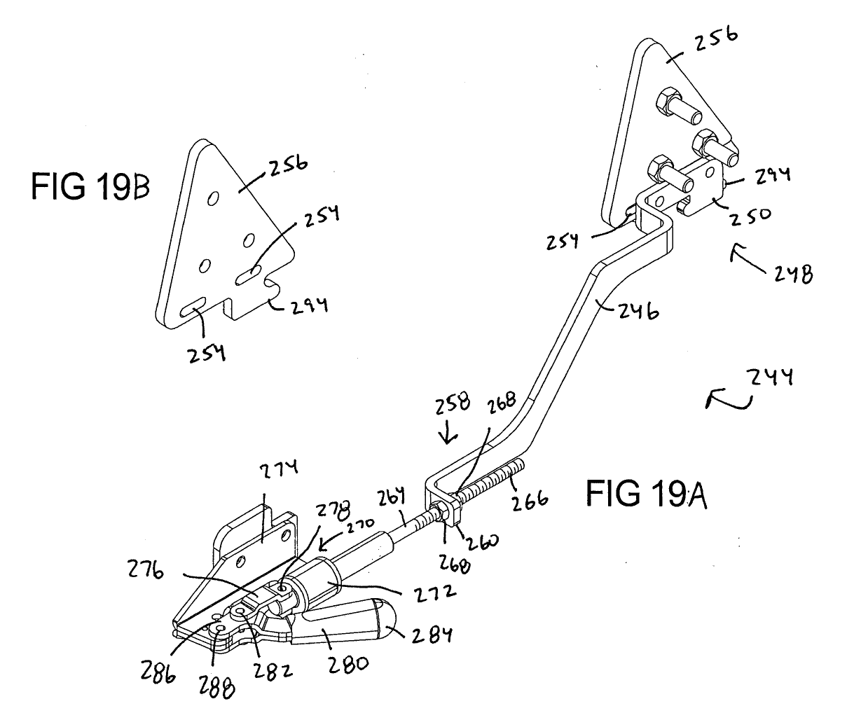

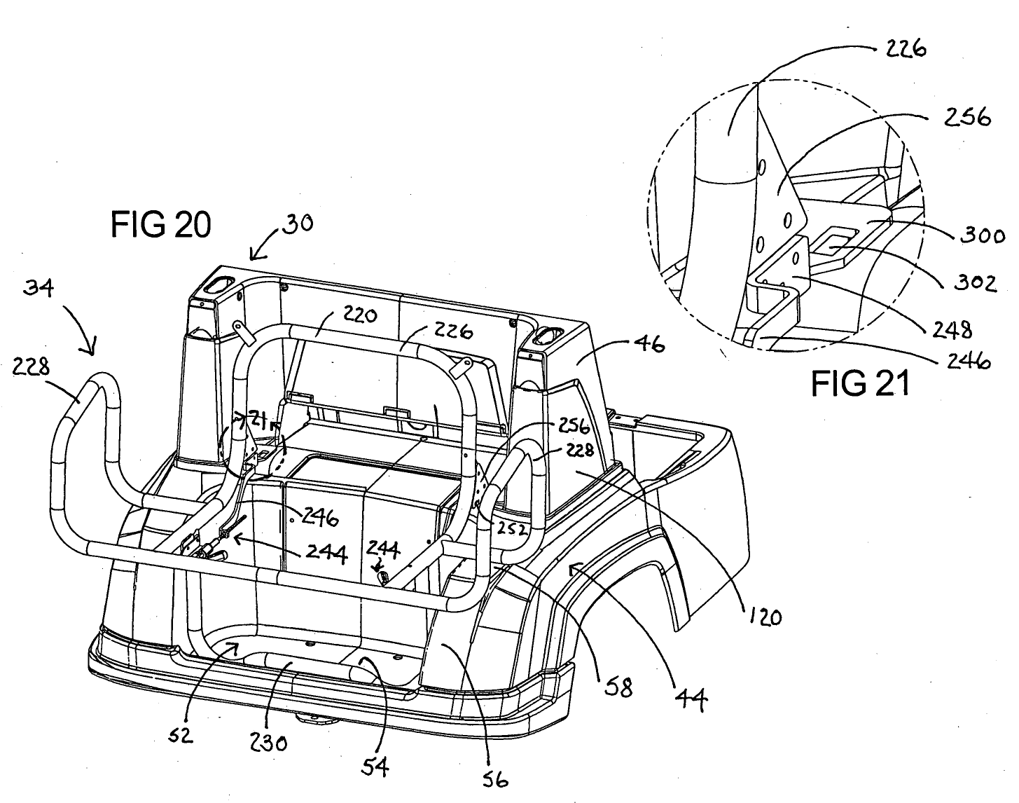

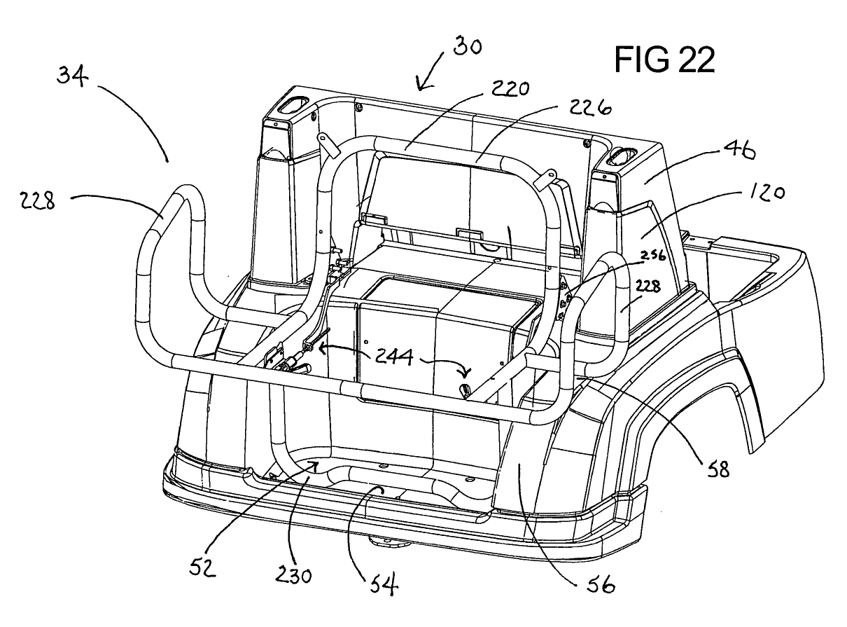

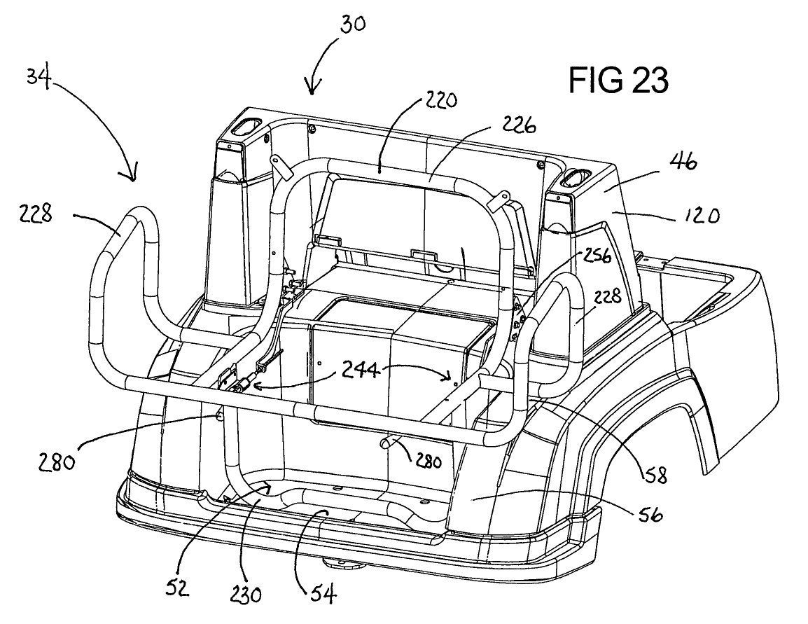

Referring now to FIGS. 2 and 16-24, details of rear-facing seat accessory 34 are shown. Rear-facing seat accessory 34 includes a seat frame 220 to which a seat back cushion 222 and a seat bottom cushion 224 are attached. In some figures, cushions 222, 224 are removed for clarity. Seat frame 220 is generally formed of U-shaped members. Seat frame 220 can include a generally U-shaped seat back portion 226, a pair of generally U-shaped arm portions 228, and a generally U-shaped lower support 230. Seat frame 220 includes a generally horizontal portion 232 to which seat back portion 226, arm portion 228, and lower support 230 are attached. Horizontal portion 232 includes a pair of axially extending sections 234 and a transversely extending section 236. Seat back portion 226, arm portions 228, lower support 230, and horizontal portion 232 can be welded together. Additionally, some of the various sections of these portions can be integral to one another and formed from a single piece that is then welded to the remaining pieces. Seat frame 220 can be tubular and can be metal.

Seat bottom cushion 224 is attached to and supported by horizontal portion 232 and is disposed between arm portions 228. Seat back cushion 222 is attached to seat back portion 226. A transverse section 238 of lower support 230 can have a raised portion to accommodate surface features of lower surface 54 of rear bed 52 of utility vehicle 30. For example, the raised portion can accommodate an axially extending divider that separates lower surface 54 into two separate areas.

Seat frame 220 includes a pair of locking members 244 operable to secure rear-facing seat accessory 34 to utility vehicle 30. Each locking member 244 includes an axially extending articulating arm 246 that moves axially during operation of locking member 244. A front end portion 248 of articulating arm 246 includes a downwardly extending rearwardly opening hook 250 and transversely outwardly extending projections 252 (best seen in FIGS. 17, 18, 20, 23, and 24). Projections 252 are disposed in and move along axially extending slots 254 in a bracket 256 attached to seat frame 220.

A rear end portion 258 of articulating arm 246 includes a transversely inwardly extending flange 260 with an opening extending axially therethrough. An axially articulating rod 264 extends through the opening in flange 260 of articulating arm 246. Rod 264 has a threaded portion 266 that extends through the opening in flange 260. Rod 264 is fixed relative to flange 260 by a pair of nuts 268 engaged with threaded portion 266 on opposite sides of flange 260. Nuts 268 and threaded portion 266 allow the position of rod 264 relative to flange 260 to be changed so that a desired axial displacement of articulating arm 246 can be achieved when operating locking member 244.

A rear portion 270 of rod 264 extends through a bushing 272 fixedly coupled to a bracket 274. Bracket 274 is fixedly secured to axial sections 234 of seat frame 220 adjacent lower support 230 and transverse section 236. Bushing 272 guides the axial motion of rod 264. Rear portion 270 of rod 264 is pivotally coupled to the ends of a pair of links 276 at pivot 278. Opposite ends of links 276 are pivotally coupled to an intermediate portion of a latch 280 at pivot 282. Latch 280 includes a free end 284 and an opposite end 286 pivotally coupled to bracket 274 at pivot 288. With this arrangement, movement of latch 280 about pivot 288 results in axial movement of rod 264 which is translated into axial movement of articulating arm 246.

Bracket 256 is attached to seat back portion 226 of seat frame 220 adjacent the juncture of seat back portion 226 and axial sections 234. Brackets 256 include a downwardly extending and forwardly opening hook portion 294. Hook portion 250 of articulating arm 246 moves relative to hook portion 294 of bracket 256 during movement of latch 280.

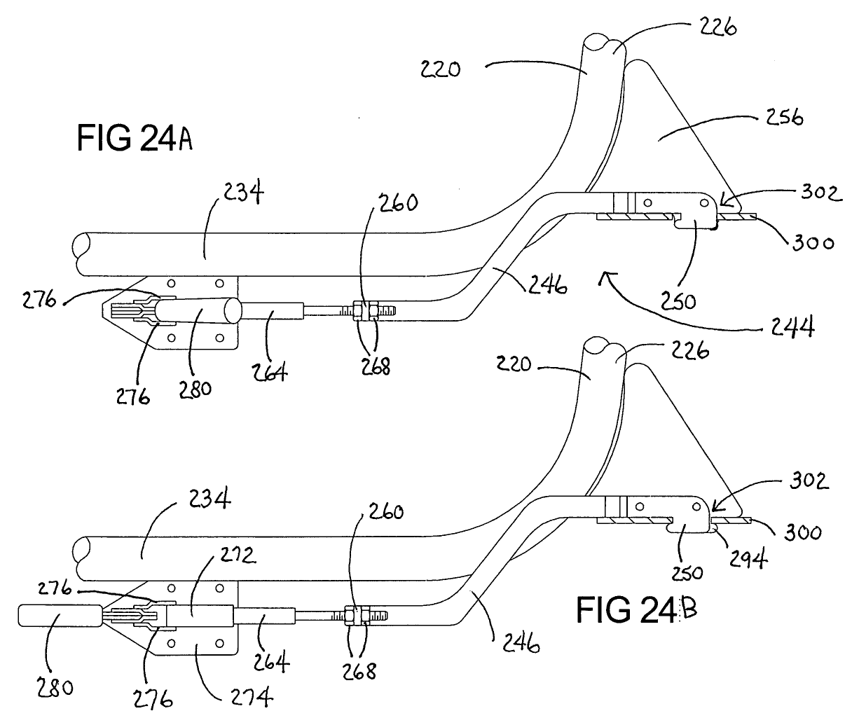

Utility vehicle 30 includes a pair of receiver plates 300 with vertically extending apertures 302 therein. Receiver plates 300 are disposed on rear portion 44 of utility vehicle 30 between end portions 120 of vertical support 46. Apertures 302 are configured to receive hook portions 250, 294 of articulating arm 246 and bracket 256. As shown in FIGS. 24A and B, latch 280 can be moved from a first unlocked position, as shown in FIG. 24A, to a second locked position, as shown in FIG. 24B. Latch 280, when in the locked position, can be in an over-center position. In this position, forward axial force exerted on latch 280 by articulating arm 246 and/or rod 264 does not tend to cause latch 280 to pivot toward the unlatched position. Thus, locking member 244 can be self-locking. If desired, additional securing means, such as a securing pin (not shown) can be employed to further inhibit the inadvertent movement of latch 280 from the locked position to the unlocked position.

Movement of latch 280, from the unlocked position to the locked position, causes articulating arm 246 to move rearwardly relative to receiver plate 300. As a result, hook portion 250 moves relative to receiver plate 300 and hook 294 of bracket 256. This motion causes hook portions 294 and 250 to axially push in opposite directions against receiver plates 300 and secure rear-facing seat accessory 34 to utility vehicle 30.

When installing rear-facing seat accessory 34, golfing accessory 32 or storage box accessory 38, if installed in utility vehicle 30, is first removed. Locking members 244 are moved to the unlocked position, if not already in that position. Rear-facing seat accessory 34 can then be positioned in rear bed 52 of utility vehicle 30. When positioned in rear bed 52, lower support 230 engages with lower surface 54 and arm portions 228 engage with bearing surfaces 58 of side portions 56. In this manner, lower surface 54 of rear bed 52 and bearing surfaces 58 of side portions 56 provide a support for rear-facing seat accessory 34. When positioning rear-facing seat accessory 34 in rear bed 52, hook portions 294, 250 of brackets 256 and articulating arms 246 are positioned through apertures 302 in receiver plates 300. With rear-facing seat accessory 34 so situated, latches 280 can be moved from the unlocked position to the locked position to firmly retain rear-facing seat accessory 34 within utility vehicle 30. To remove rear-facing seat accessory 34, the opposite sequence can be undertaken. Thus, rear-facing seat accessory 34 can be attached to and removed from utility vehicle 30 by hand and without the use of any tools.

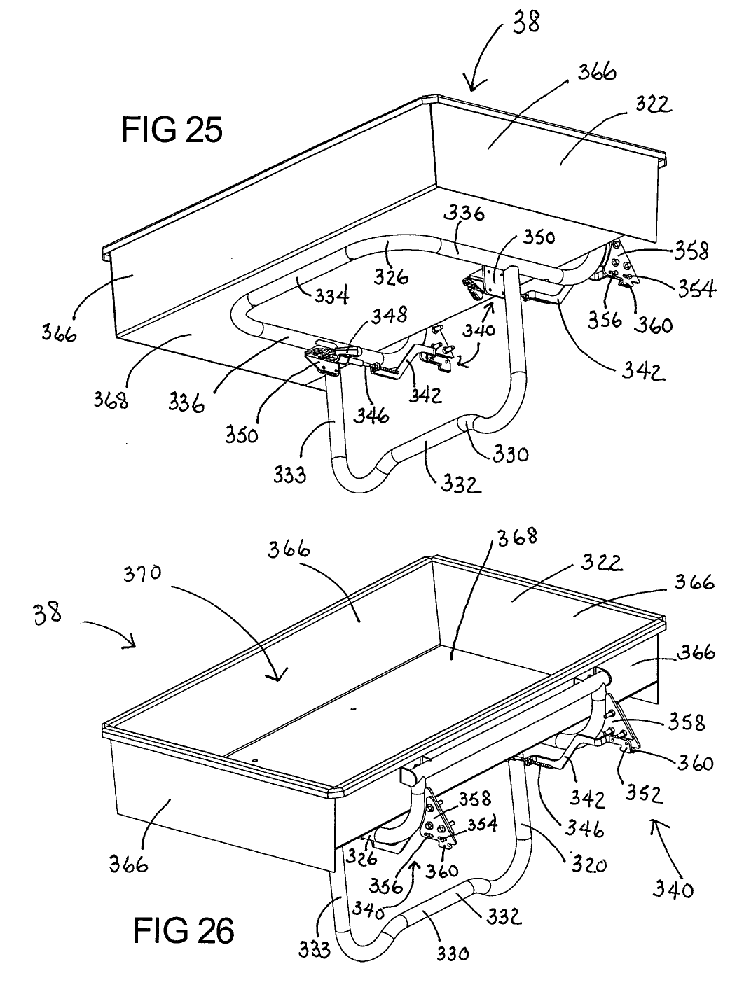

Referring now to FIGS. 3A, 3B, 25, and 26, details of storage box accessory 38 are shown. Storage box accessory 38 includes a frame 320 and a storage box 322 secured thereto. Frame 320 includes a generally a U-shaped forward vertically extending portion 324, a horizontally extending generally U-shaped portion 326 extending rearwardly from forward portion 324, and a generally U-shaped vertically extending lower support 328. Lower support 328 is similar to lower support 230 of frame 220. As such, lower support 328 includes a transverse section 330 with a raised portion 332 and vertically extending sections 333. Horizontal portion 326 includes a transverse section 334 and a pair of axially extending sections 336. Forward portion 324, horizontal portion 326, and lower support 328 can be welded together. Additionally, some of the various sections of these portions can be integral to one another and formed from a single piece that is then welded to the remaining pieces. Frame 320 can be tubular and can be metal.

Frame 320 includes a pair of locking members 340 operable to secure storage box accessory 38 to utility vehicle 30. Locking members 340 are identical to locking members 244 described above with reference to rear-facing seat accessory 34. As such, locking members 340 are not described in detail. It should be understood that locking members 340 function to retain storage box accessory 38 attached to utility vehicle 30 in the same manner that locking members 244 function to secure rear-facing seat accessory 34 to utility vehicle 30. Thus, each locking member 340 includes an axially extending articulating arm 342 pivotally coupled to a rod 346 which is linked to a latch 348 pivotally coupled to a bracket 350 fixed to axial sections 336 of horizontal portion 326. Movement of latch 348 about its pivot results in axial movement of rod 346 and articulating arm 342. The forward portion of articulating arm 342 includes a downwardly extending and rearwardly opening hook 352 and transversely outwardly extending projections 354. Projections 354 ride within axially extending slots 356 in a bracket 358 affixed to forward portion 324 of frame 320. Bracket 358 also includes a downwardly extending forwardly opening hook 360. Axial movement of articulating arm 342 causes hook 352 to move relative to hook 360 to secure storage box accessory 38 in an aperture of a retaining plate on vehicle 30.

Storage box 322 includes a plurality of sidewalls 366 extending upwardly from a lower surface 368. Sidewalls 366 and lower surface 368 form a storage cavity 370 within which loose material and objects can be positioned for transport with utility vehicle 30. While storage box 322 is shown as being rectangular, it should be appreciated that the shape, size, and dimensions of storage box 322 can vary.

When installing storage box accessory 38 on utility vehicle 30, golfing accessory 32 or rear-facing seat accessory 34, if installed in utility vehicle 30, is first removed. Locking members 340 are moved to the unlocked position, if not already in that position. Storage box accessory 38 can be positioned in rear bed 52 of vehicle 30. When positioned in rear bed 52, lower support 328 engages with lower surface 54 and bearing surfaces 58 of side portions 56 can engage horizontal portion 326. In this manner, lower surface 54 of rear bed 52 and bearing surfaces 58 of side portions 56 can provide a support for storage box accessory 38. When positioning storage box accessory 38 in rear bed 52, hook portions 360 and 352 of bracket 358 and articulating arm 342 are positioned through apertures in the receiver plates attached to utility vehicle 30. With storage box accessory 38 so situated, latches 348 can be moved from the unlocked position to the locked position to firmly retain storage box accessory 38 within utility vehicle 30. To remove storage box accessory 38, the opposite sequence is undertaken. Thus, storage box accessory 38 can be attached to and removed from utility vehicle 30 by hand and without the use of any tools. If desired, support rack accessory 36 can be attached to utility vehicle 30 along with storage box accessory 38.

Thus, a utility vehicle according to the present teachings can be configured in a variety of manners to change and/or enhance the functionality of the utility vehicle. The various interchangeable accessories can be easily attached to and removed from the utility vehicle to facilitate the changing of the configuration of the utility vehicle. Additionally, the accessories can utilize common or the same mounting features on the utility vehicle to simplify their installation and removal. The latching and locking mechanisms utilized with the interchangeable accessories can be operated by hand and do not require the use of tools to attach and remove the interchangeable accessories.

The present teachings are merely exemplary and variations to the teachings can be employed. For example, the utility vehicle can be in a configuration other than that of a golf car. Additionally, the various interchangeable accessories can be modified to correspond to the contour of the utility vehicle upon which the interchangeable accessories are to be utilized. Additionally, the latching and locking members and mechanisms can be altered to accommodate different engaging features on the utility vehicle. Thus, such variations are not to be regarded as a departure from the spirit and scope of the present teachings.

What is claimed is:

1. A removable seat for a vehicle having a bed defined by a pair of side support walls, the seat comprising:
a frame;
a seat coupled to the frame;
a locking member coupled to said frame, said locking member having a rotatable handle having a disengaged position and an engaged position, said locking member further having a hook portion configured to engage an aperture defined on the vehicle,
wherein the removable seat can be selectively attached to the vehicle and secured thereto by moving said locking member to said engaged position and removed from the vehicle when said locking member is in said disengaged position.

2. The removable seat according to claim 1, wherein said frame is configured to be placed between the pair of side walls.

3. The removable seat according to claim 2, wherein said frame defines an arm member having a bearing surface which is configured to engage a top surface of one of the side walls.

4. The removable seat according to claim 1, wherein said locking member comprises an articulated member pivotally coupled to said handle member.

5. The removable seat assembly according to claim 4, wherein the articulating member is pivotally coupled to the hook portion.

6. The removable seat assembly according to claim 1, wherein the frame comprises a generally U-shaped back bracket and a pair of U-shaped arm members coupled to the U-shaped back bracket.

7. A removable accessory for a utility vehicle having a rear bed defined by a lower surface and pair of side support walls, the removable accessory comprising:
a frame;
a support surface coupled to the frame, said support surface and frame forming at least one of a removable rear-facing seat, a removable storage box, and a removable generally horizontal support platform that extends rearwardly beyond a rear bumper of the vehicle when attached thereto; and
a locking member coupled to said frame, said locking member having a disengaged position and an engaged position, said locking member further having an engaging portion configured to engage a retaining feature on the vehicle,
wherein the removable accessory can be selectively attached to the vehicle and secured thereto by moving said locking member to said engaged position and can be removed from the vehicle when said locking member is in said disengaged position.

8. The removable accessory of claim 7, wherein said support surface and frame form said removable rear-facing seat, said support surface includes a cushion, said frame includes arm members that engage with and are supported by top surfaces of the side support walls and said frame includes a lower support member that extends downwardly from said frame between the support walls and engages with and is supported by the lower surface of the bed.

9. The removable accessory of claim 7, wherein said support surface and frame form said removable storage box, said support surface includes a generally horizontal bottom member and a plurality of sidewalls extending upwardly therefrom, said frame includes a transversely extending member that supports said bottom member, and said frame includes a lower support member that extends downwardly between the support walls and engages with and is supported by the lower surface of the bed.

10. The removable accessory of claim 7, wherein said support surface and frame form said removable horizontal support platform, said frame includes a pair of axially extending members each having a front portion with a pair of vertically spaced apart sections that selectively engage with opposite sides of a frame member of the vehicle to support said platform from the vehicle in a cantilever manner.

11. The removable accessory of claim 10, wherein the locking member includes an articulating rod having a hook portion that engages with a hitch on a rear of the vehicle and a pivotal handle coupled to said rod, said handle pivoting between said engaged and disengaged positions to selectively secure said platform to the vehicle through the interaction of said hook and said hitch, and said handle is self-locking in said engaged position.

12. The removable accessory of claim 11, wherein said rod articulates axially and said handle pivots axially.

13. The removable accessory of claim 11, wherein said locking member includes a retaining member operable to selectively prevent movement of said handle from said engaged position to said disengaged position.

14. The removable accessory of claim 7, wherein said locking member is a quick-release mechanism that enables said frame to be attached to and removed from the vehicle without the use of tools.

15. The removable accessory of claim 7, wherein the locking member includes an articulating arm coupled to a handle that pivots relative to said frame, said arm including a hook portion that engages with an aperture on the vehicle to retain the removable accessory to the vehicle, and movement of said handle between said engaged and disengaged positions causes axial movement of said hook portion.

16. The removable accessory of claim 15, wherein said frame includes a bracket with a hook portion that engages with said aperture on the vehicle, said hook portion of said arm is coupled to said bracket and said hook portion of said arm moves axially relative to said hook portion of said bracket when said handle moves between said engaged and disengaged positions.

17. The removable accessory of claim 15, where said locking member includes a threaded rod coupling said arm to said handle and said rod enables an axial displacement of said arm to be adjusted.

18. A reconfigurable utility vehicle comprising:
a front portion including a driver's area;
a rear portion including rear bed having a lower surface and upwardly extending support walls;
a retainer having a opening therein disposed adjacent a top surface of said support walls;
a rear hitch; and
a plurality of interchangeable accessories that can be selectively coupled to and removed from the vehicle to change a configuration of the vehicle, said accessories including at least two of a golfing accessory having a bag support member and a basket, a rear-facing seat, a storage bed, and a rearwardly extending platform.

19. The reconfigurable utility vehicle of claim 18, wherein said accessories can be attached to and removed from the vehicle without the use of tools.

20. The reconfigurable utility vehicle of claim 19, wherein storage bed, said rear-facing seat and said platform accessories are secured to the vehicle using quick-releasing locking mechanisms.

21. The reconfigurable utility vehicle of claim 20, wherein said storage bed and said rear-facing seat accessories use identical locking mechanisms.

22. The reconfigurable utility vehicle of claim 21, wherein said storage bed and said rear-facing seat accessories locking mechanisms each include an articulating arm having a hook portion that engages with said opening in said retainer, a pivotal handle coupled to said arm, and movement of said handle between engaged and disengaged positions causing axial movement of said hook portion relative to said retainer.

23. The reconfigurable utility vehicle of claim 20, wherein said platform accessory includes a pair of axially extending members each having an end with vertically spaced apart sections that engage with opposite sides of a rear frame member of the vehicle to support the platform from the vehicle in a cantilever manner.

24. The reconfigurable utility vehicle of claim 23, wherein said platform accessory locking mechanism includes an articulating arm having a hook portion that engages with said hitch, and a pivotal handle coupled to said arm, movement of said handle between engaged and disengaged positions moving said hook portion relative to said hitch.

25. The reconfigurable utility vehicle of claim 18, wherein said vehicle includes a vertically extending support member separating said front and rear portions of the vehicle and said bag support member is removably attachable to said vertical support member and said basket is removably attachable to said bag support member and to said vertical support member.

26. The reconfigurable utility vehicle of claim 18, wherein said platform accessory can be used in conjunction with any of said other accessories, and only one of said golfing accessory, said rear-facing seat accessory and said storage box accessory can be used at any one time.

27. A support rack configured to be selectively coupled to a rear transversely extending beam of a vehicle, the support rack comprising:
a platform portion having a pair of locking flanges configured to engage the transverse beam; and
a locking mechanism having an actuable handle and a locking arm, said locking arm configured to engage an aperture defined on the vehicle.

28. The support rack according to claim 27, wherein said handle is movable from a disengaged position to an engaged position, and wherein said locking arm defines a hook portion configured to engage the aperture when said handle is in said engaged position.

29. The support rack according to claim 28, wherein said hook portion engages with an aperture in a rear hitch on the vehicle.

30. The support rack according to claim 27, wherein said platform comprises a vertically extending U-shaped support bar.

31. The support rack according to claim 27, wherein said platform comprises a plurality of transverse support members.

32. The support rack according to claim 27, wherein said platform comprises a pair of axial beams, and wherein said locking mechanism is between said axial beams.

33. The support rack according to claim 27, wherein said platform comprises a pair of axial beams and said flanges are L-shaped brackets welded to end portions of said axial beams.

34. The support rack according to claim 33, wherein said L-shaped brackets and a surface of said axial beams define opposite bearing surfaces configured to engage opposite engaging surfaces of the transverse beam.

35. The support rack according to claim 33, wherein said axial beams and said flanges define a pair of generally square engagement surfaces.

36. The support rack according to claim 32, wherein said axial beams comprise a bearing surface configured to engage at least one surface of the transverse beam.

37. The support rack according to claim 27, wherein said flanges engage the transverse beam and cantilever said platform from the transverse beam.
